(19) United States
(12) Patent Application Publication
(10) Pub. No.: US 2007/0277520 A1
(43) Pub. Date: Dec. 6, 2007

(54) HYDRAULIC MODULE WITH TWO INTEGRATED SWASHPLATE OR OBLIQUE AXIS DRIVE UNITS

(75) Inventor: Wilhelm Gollner, Neumunster (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC, Ames, IA (US)

(21) Appl. No.: 11/682,730

(22) Filed: Mar. 6, 2007

(30) Foreign Application Priority Data
May 31, 2006 (DE) 10 2006 025 347.7

(51) Int. Cl. F16D 39/00

(52) U.S. Cl. 60/492

(57) ABSTRACT

The invention relates to a hydraulic module for hydrostatic mechanical gearboxes having two swashplates or oblique axis drive units which are integrated in the hydraulic module. The swashplate drive units are mounted in a common housing with parallel drive shafts and each have a rotating cylinder block with expellers which can move therein and which are supported in a sliding fashion on a double swashplate whose pivot angle is adjustable by means of a servo system. The double swashplate is designed to carry out positively coupled common adjustment of the volume flow of the two drive units and is equipped with bearing faces for the expellers of the respective drive units, said bearing faces having different angles of inclination relative to the respective drive shaft. The oblique axis drive units each have a cylinder block with expellers which can move therein and which are each pivotably mounted on the coaxial shafts.

### BACKGROUND OF THE INVENTION

The invention relates to a hydraulic module for hydrostatic mechanical gearboxes having two integrated swashplate or oblique axis drive units according to the features of claims 1 and 2.

For hydromechanical gearboxes, in particular those with power branching, adjustable swashplate or oblique axis drive units are used which operate as a pump or a motor.

Swashplate drive units have a rotating cylinder drum with expeller pistons which are distributed over the circumference thereof can move in the cylinders and are supported in a sliding fashion on a swashplate. The pivot angle of the swashplate can be adjusted by means of a servo system. As the pivot angle increases the piston stroke in the cylinder bores and thus, the volume flow becomes larger.

Oblique axis drive units each have a cylinder drum which is mounted so as to be rotatable about its longitudinal centre axis and also has cylinder bores distributed over its circumference in which bores the pistons can be displaced. In order to adjust the volume flow the cylinder drum can pivot about a pivot axis which extends transversely with respect to its rotational axis, as a result of which the longitudinal centre axis of the cylinder drum forms an adjustable angle with the axis of the drive shaft. The pistons are supported here in an articulated fashion at the adjustable angle on the drive flange of the shaft.

In order to be able to adjust an oblique axis drive unit the corresponding “end housing” must be of rotatable design. This is typically brought about by means of a yoke which accommodates in each case the cylinder block of the pump or of the motor and is mounted in a pivotable fashion on the fixed housing component. In order to direct the volume flow into the fixed housing rotational bushings must be provided which make large demands on the seals because relatively large gaps at high pressures of typically up to 570 bar at temperatures of, for example, 125° C. have to be coped with.

A hydraulic module with two drive units and respectively assigned yokes of the type described is known from DE 102004030147 A1.

In power branching transmissions a pump and one or more hydraulic motors of the type described at the beginning form a continuously adjustable hydrostatic gearbox. The power which is applied by an internal combustion engine via the drive shaft branches here to the hydrostatic gearbox and to the input shaft of a summing gear mechanism. In the summing gear mechanism the rotational speeds and torques of the hydrostatic gearbox and of the drive machine are combined again. This thus provides a gearbox with a continuously variable transmission ratio for a certain speed range, said gearbox having the known advantages that within this speed range it is possible to drive at an optimum engine speed in any driving state and interruptions in the tractive force due to gear changing operations are avoided. However, in order to cover relatively large speed ranges a mechanical range change gearbox is generally connected downstream which gearbox may be of more or less complicated design depending on the demands which are made. A relevant power branching transmission for tractors is described in DE 4209950 A1.

### SUMMARY OF THE INVENTION

The present invention is intended to provide an improved hydraulic module for hydrostatic mechanical gearboxes.

This is achieved according to the invention with a hydraulic module having two swashplate drive units which are integrated therein and which each have a rotating cylinder block with expellers which can move therein. The expellers are supported in a sliding fashion on a common double swashplate whose pivot angle is adjustable by means of a servo system. The double swashplate is designed to carry out positively coupled common adjustment of the volume flow of the two drive units and has, for this purpose, bearing faces for the expellers of the respective drive units said bearing faces having different angles of inclination relative to the respective drive shaft. The two drive units are mounted in a common housing with parallel drive shafts.

The aforesaid objective is also achieved according to the invention with a hydraulic module for hydrostatic mechanical gearboxes and two oblique axis drive units which are integrated in the hydraulic module and which each have a cylinder block with expellers which can move therein, the expellers each being pivotably mounted on axially parallel shafts. The cylinder blocks of the two oblique axis drive units are mounted in a common yoke with different pivot angles and are positively pivotable together with the yoke by means of a servo system in order to adjust the volume flow.

It has surprisingly become clear that it is possible to dispense with the independent control of the two drive units and the associated degrees of freedom for the sake of a simplified design. The advantages are that only a single pivot mechanism and a single so called control with servo piston and control valve are necessary for the two drive units. The connecting lines can be kept very short and within the unit so that the previous sealing problems are avoided. This provides a considerable reduction in cost and ensures greater reliability during operation.

One of the drive units preferably operates as a pump and the other as a hydraulic motor. The home position of the pump is at a minimum pivot angle, preferably 0° here, while the hydraulic motor is at the maximum pivot angle in its home position. In order to compensate for volume flow losses the home position of the pump can be several degrees angle below 0°, i.e., at the minimum pivot angle the pump can be pivoted slightly in the opposite direction from its actual adjustment range. This makes it possible to compensate for volume flow losses which otherwise cause the vehicle to carry on moving slowly in the neutral state in specific off road situations.

According to the invention the pump can be adjusted from the minimum pivot angle, that is to say typically a pivot angle in the region around 0° to the maximum angle while at the same time the motor is pivoted synchronously from the maximum angle to a minimum angle which is 0° by the mechanical positive coupling. In oblique axis drive units the maximum pivot angle is in the range from 40° to 50° and in swashplate drive units in the range from 15° to 25°.

In oblique axis drive units a particular advantage is obtained by virtue of the fact that the connecting ducts are formed between the two drive units within the yoke and feed valves and scavenging valves are also provided in the yoke because in this way complicated rotational bushings with narrow fits and a large number of sealing problems are dispensed with. This yoke is preferably mounted with roller bearings, in particular with two tapered roller bearings on the fixed housing component. This provides a significantly simpler design than is possible with conventional yokes which are mounted on a rotary journal on which the rotational bushings for the main oil flow also have to be formed at the same time. A pivoting connection is advantageously provided between the yoke and the housing on which connection the ports for feeding in and discharging scavenging oil are provided on the pivot axis of the yoke. This results in a comparatively simple connection which can be made in each case by means of a pipe element which is inserted with play at the pivot axis on each side of the double yoke or on one side of the yoke with two coaxial pipe elements. This makes rotation easily possible.

The hydraulic module according to the invention is preferably used as a hydrostatic gearbox in power branching transmissions, in particular for tractors.

Further features and advantages of the invention emerge from the subsequent description of the exemplary embodiments.

### BRIEF DESCRIPTION OF THE DRAWINGS

FIG. 1 shows a hydraulic module with swashplate drive units in section in the plane of the drive shafts;

FIG. 2 shows the hydraulic module from FIG. 1 viewed in the direction of the pivot axis;

FIG. 3 shows the double swashplate according to the exemplary embodiment in FIGS. 1 and 2;

FIG. 4 shows a hydraulic module with oblique axis drive units viewed in the direction of the pivot axis;

FIG. 5 is an overall view of the hydraulic module with oblique axis drive units;

FIG. 6 shows the double yoke of the hydraulic module viewed from the direction of the drive shafts;

FIG. 7 shows an example of the angular relationships between the drive units and the double yoke;

FIG. 8 shows an example of the angular relationships between the drive units when volume flow compensation occurs;

FIG. 9 shows the double yoke in a front view with scavenging port feed and pressure protector;

FIG. 10 shows the hydraulic connection for feeding or scavenging;

FIG. 11 shows a further configuration of the hydraulic connection for feeding and scavenging; and

FIG. 12 shows the servo control for adjusting the pivot angle.

### DETAILED DESCRIPTION OF THE PREFERRED EMBODIMENTS

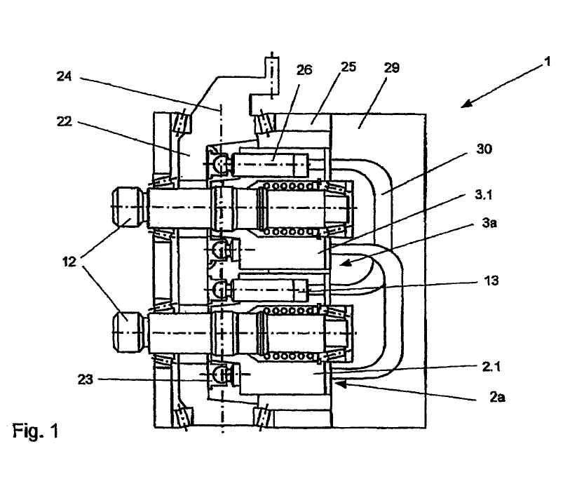

FIG. 1 shows a hydraulic module 1 according to the invention which is used in hydrostatic mechanical gearboxes. It comprises two drive units of a swashplate design specifically a pump 2a and a hydraulic motor 3a which are mounted with parallel drive shafts 12 in a common housing 25, 29.

FIG. 1 shows here a section in the plane extending through the parallel drive shafts 12. The two drive units 2a, 3a each have a cylinder block 2.1, 3.1 which rotates with the shaft 12 and has expeller pistons 26 which are displaceable in the cylinders and are supported on a common swashplate 22 by means of sliding shoes 23. The swashplate 22 can be rotated about the pivot axis 24 by means of a servo system (not illustrated) and has a bearing face for the pump 2a and one for the hydraulic motor 3a, each with different oblique positions which are however not shown in the section along the central plane of the drive units.

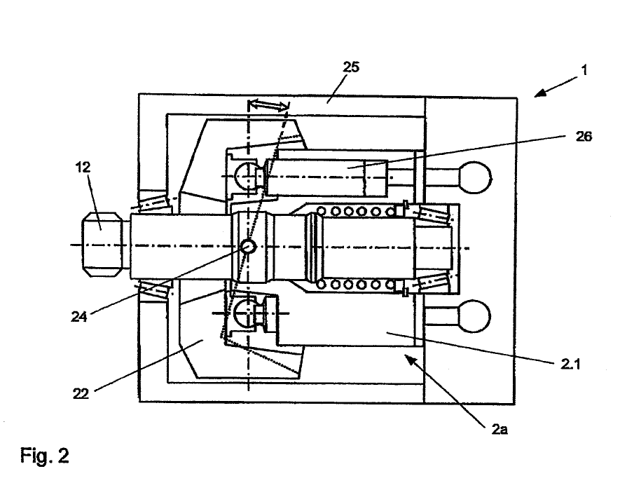

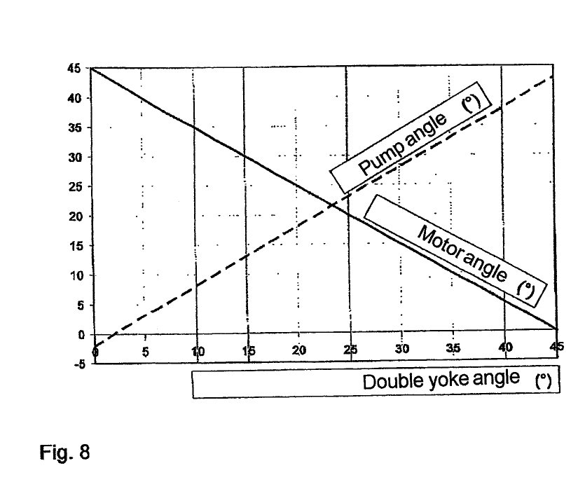

FIG. 2 shows the same arrangement from the side viewed in the direction of the pivot axis 24. Pump 2a and motor 3a are located one behind the other here. The expeller pistons 26 of the pump cylinder block 2.1 are supported on the swashplate 22 which is at the pivot angle zero, i.e., in the neutral position for the pump in the illustration in FIG. 2. For the hydraulic motor which lies behind it and is concealed by the pump, the bearing face has in contrast, an angle of inclination which corresponds to the maximum pivot angle and is indicated by the double arrow in the figure. The swashplate 22 is pivoted in such a way that the pump is adjusted from the neutral position to a maximum pivot angle, i.e., a maximum value of the volume flow. At the same time the motor adjusts from the maximum initial value of its swept volume to zero. The minimum pivot angle for the pump can, for reasons of compensation, lie slightly below or above zero as will be explained in more detail below with respect to FIG. 8.

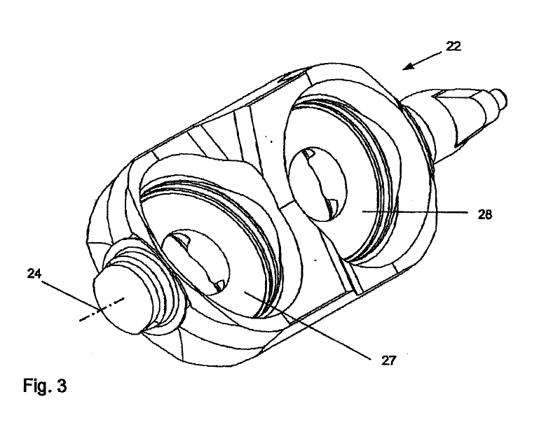

FIG. 3 shows the double swashplate 22 of the swashplate unit. The double swashplate 22 can be adjusted about the pivot axis 24 by means of a servo system and has in each case a bearing face 27, 28 for the expeller pistons of the pump and hydraulic motor. The two bearing faces 27, 28 have different angles of inclination. This means that in the neutral position the pump is at the pivot angle 0°, while at the same time the hydraulic motor has an adjustment corresponding to its maximum swept volume. When the pivot angle of the double swashplate 22 changes, the pump adjusts from its home position to its maximum adjustment angle at which it delivers the maximum volume flow, while at the same time the hydraulic motor is positively and synchronously adjusted from the maximum to the minimum pivot angle.

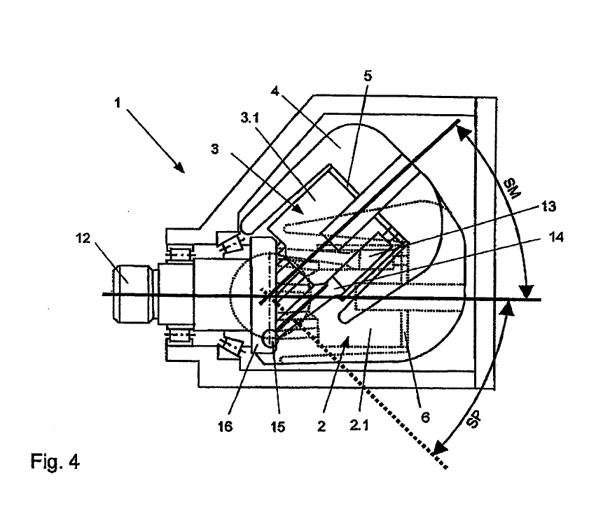

FIG. 4 shows the principle of a hydraulic module according to the invention with oblique axis drive units in the direction of the pivot axis. Therefore, of the two coaxial drive shafts 12 only that of the hydraulic motor 3 can be seen. In this illustration the motor 3 and the pump 2 are again located one behind the other in their respective home position, i.e., the pump 2 is located with its cylinder block 2.1 in the 0° position, that is to say in the state which is virtually without delivery, while the hydraulic motor 3 and its cylinder block assume the maximum pivot angle of approximately 45° with respect to the axis of the drive shaft 12 at which angle the hydraulic motor has its maximum swept volume. The pistons 14 of the hydraulic motor 3 which are mounted with the piston head 15 in the drive flange 16 of the shaft 12 reach the maximum travel in the cylinders 13 here. The cylinder block 3.1 bears against a valve plate 5 in a known fashion here.

The pump 2 and hydraulic motor 3 are embraced by the double yoke 4 and are positively pivoted together with it. At the same time the hydraulic motor 3 moves over the pivoting range SM between a maximum and a minimum angle. In the illustrated example the pivot angle is 45° at maximum and 0° at minimum. At the same time the pump 2 pivots with its cylinder block 2.1 and its valve plate 6 which are illustrated by dashed lines in the figure over the angular range SP from 0° to 45°, i.e., it adjusts from zero to maximum volume flow.

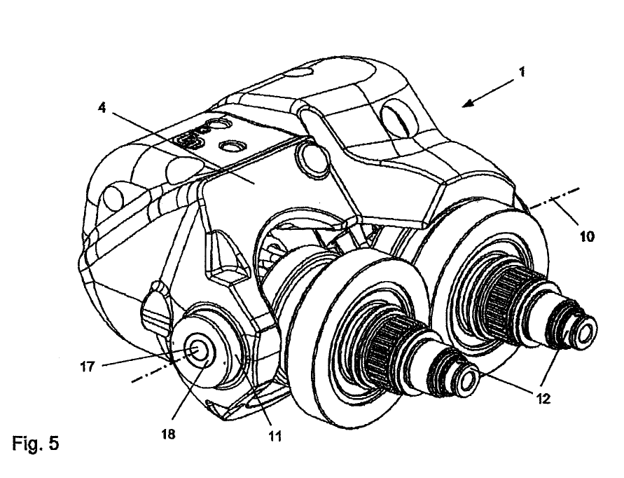

FIG. 5 is an overall view of the hydraulic module with oblique axis drive units. The fixed part of the hydraulic module 1 contains the parallel drive shafts 12 on whose flanges the respective expellers are pivotably mounted. The respective cylinder blocks of the pump and hydraulic motor are embraced by the double yoke 4 which can be adjusted about the pivot axis 10 by means of a servo system. The yoke has a journal 11 on each side on which journal 11 the ports for the feeding 17 and scavenging 18 are also provided. The connecting ducts between the pump and the motor are formed in the yoke as a result of which long connecting ducts, bushings and seals which are difficult to cope with such as are necessary in the case of separate drive units, which can be controlled independently of one another, are dispensed with.

The pump 2 and motor 3 are positively adjusted together with the yoke 4. This is in turn carried out in such a way that the pump 2 which is in the region of the pivot angle 0° in the home position is adjusted in the direction of its maximum pivot angle while at the same time the motor 3 which is at its maximum pivot angle in its home position is adjusted in the direction of pivoting towards 0° up to a minimum value.

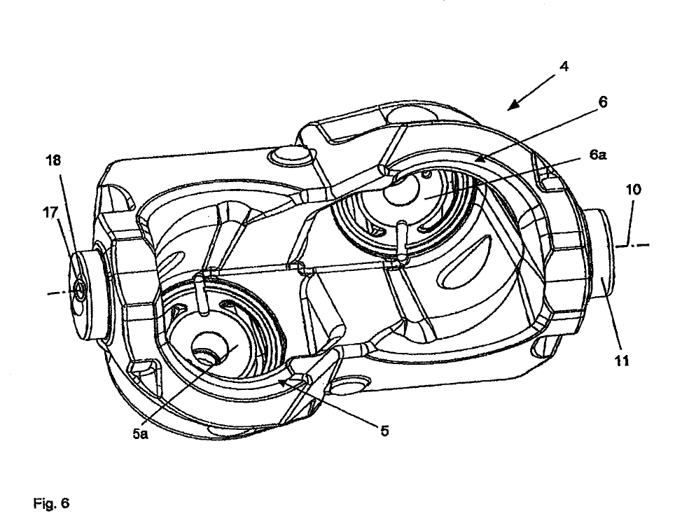

FIG. 6 shows the removed double yoke 4 from the direction of the drive shafts. The bearing journals 11 which are located on each side and at which the double yoke 4 can be pivoted about the pivot axis 10 and at which the ports for the feeding 17 and scavenging are formed are illustrated. Furthermore, the support faces 5a, 6a which are offset with respect to one another at an angle can be seen in the common yoke 4 for the valve plates 5, 6 of the motor and of the pump.

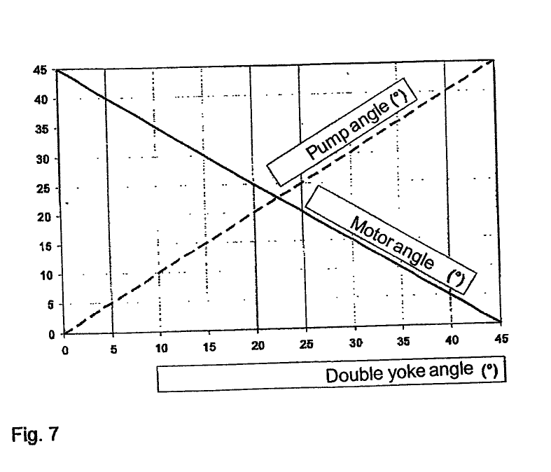

The described angular relationship is illustrated in FIG. 7. It is conditioned by the mechanical positive coupling of the two drive units in the common double yoke while in the illustrated case the pump pivots between 0° and 45° and the hydraulic motor between 45° and 0°.

FIG. 8 shows that the adjustment range does not necessarily have to extend in each case from 0° to 45° but rather can be predefined separately for each drive unit. This fact can be used to compensate for volumetric losses, and for example, to provide active stationary state control. This may be necessary in order to avoid a creeping movement of the vehicle in the neutral position of the hydraulic module in an off road situation on an incline and means that the minimum pivot angle of the pump can differ slightly from 0°. For example, FIG. 8 shows a pump adjustment from −2.5° to 42.5°, while the hydraulic motor pivots synchronously from 45° to 0°. In the same way the adjustment range of the hydraulic motor can also be displaced, for example, slightly towards positive values.

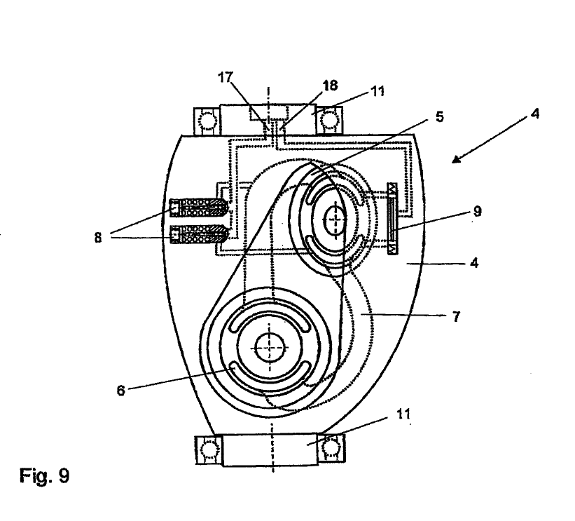

FIG. 9 shows the double yoke 4 in a front view with the devices for scavenging and for feeding in and for pressure protection. The connecting ducts 7 which run in the interior of the yoke between the valve plate 5 of the hydraulic motor and the valve plate 6 of the pump as well as fluid lines for feeding in and scavenging the ports of which are led outwards for example, at a journal like projection 11 of the yoke 4 at a pivoting connection are shown. Valves 8 are provided in each case between the port and the valve plates 5, 6 in the line for feeding 17 said valves 8 functioning on the one hand as high pressure limiting valves and on the other hand, also assuming the function of the feed valves. In the lines which lead to the scavenging port 18 a scavenging slide 9 is provided which, like the high pressure valves, is also integrated in the double yoke 4.

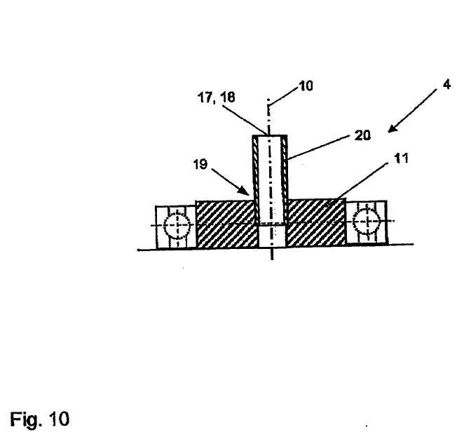

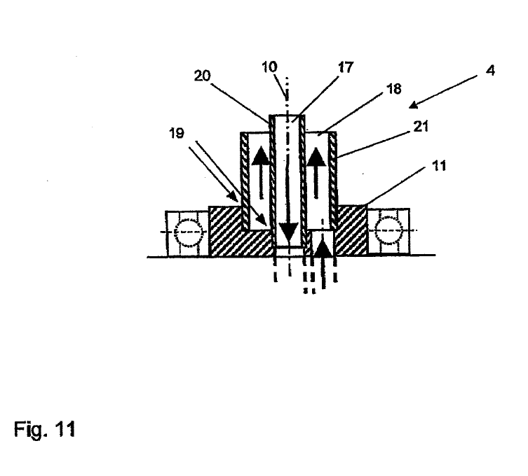

FIGS. 10 and 11 show possible ways of implementing the connection in the feed port 17 and the scavenging port 18. The connection is formed according to FIG. 10 by a pipe element 20 which is fitted with play 19 with a length which is sufficient for the sealing effect into the journal 11 of the yoke 4 in the coaxial direction with respect to the pivot axis 10. The seal is thus provided by metallic means over the sealing length for which approximately 5 mm is sufficient, for example. This makes it possible for the connecting piece to turn. This principle is further developed in FIG. 11. The pipe element 20 which is surrounded coaxially by the pipe element 21 for scavenging 18 is used for feeding 17. Both pipe elements are in turn fitted with sufficient length into the journal of the yoke 4 with play 19.

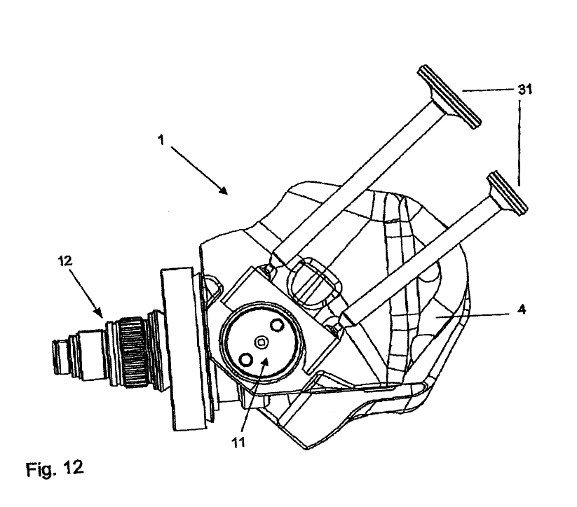

FIG. 12 shows the hydraulic module 1 with the drive shafts 12 and the double yoke 4 with which the pump and hydraulic motor are positively coupled in a mechanical fashion such that when the pump pivots from 0° to 45°, the hydraulic motor is adjusted at the same time from 45° to 0°. The adjustment is carried out by a servo system whose servo pistons 31 rotate the double yoke 4 about the pivot bearing 11.

The invention thus provides a compact unit for a hydrostatic drive with which the expenditure on the two drive units which are usually separate is considerably reduced which is much more cost effective and is significantly more reliable during operation.

What is claimed is:

1. Hydraulic module for hydrostatic mechanical gearboxes:
having two swashplate drive units (2a, 3a) which are integrated in the hydraulic module (1) and which each have a rotating cylinder block (2.1, 3.1) with expellers (26) which can move therein and which are supported in a sliding fashion on a double swashplate (22) whose pivot angle is adjustable by means of a servo system;
the double swashplate (22) being designed to carry out positively coupled common adjustment of the volume flow of the two drive units (2, 3) and being equipped with bearing faces (27, 28) for the expellers (26) of the respective drive units, said bearing faces (27, 28) having different angles of inclination relative to the respective drive shaft (12); and
the two drive units (2, 3) being mounted in a common housing (25, 29) with parallel drive shaft (12).

2. Hydraulic module for hydrostatic mechanical gearboxes:
having two oblique axis drive units (2, 3) which are integrated in the hydraulic module (1) and which each have a cylinder block (2.1, 3.1) with expellers (13, 14) which can move therein and which are each pivotably mounted on axially parallel shafts (12),
the cylinder blocks (2.1, 3.1) of the two oblique axis drive units (2, 3) being mounted with different pivot angles in a common yoke (double yoke 4); and
being positively pivotable together with the yoke (4) by means of a servo system in order to adjust the volume flow.

3. Hydraulic module according to claim 1 in which one drive unit operates as a pump (2, 2a) and one drive unit operates as a hydraulic motor (3, 3a).

4. Hydraulic module according to claim 3 in which in the home position the pump (2, 2a) is at a minimum pivot angle with respect to the axis of the drive shaft and in the home position the hydraulic motor (3, 3a) is at the maximum pivot angle.

5. Hydraulic module according to claim 3 in which the pump (2, 2a) can be adjusted from the minimum pivot angle to the maximum angle while at the same time the motor (3) is adjusted synchronously from 15 the maximum to the minimum angle.

6. Hydraulic module according to claim 4 in which the minimum pivot angle is in the region of 0°, and the maximum pivot angle for oblique axis drive units is in the range from 40° to 50°, and for swashplate drive units is in the range from 15° to 25°.

7. Hydraulic module according to claim 3 in which in order to compensate volumetric losses, the minimum pivot angle of the pump (2, 2a) is a few degrees angle below 0° in the negative adjustment region if the maximum pivot angle defines the positive pivoting direction.

8. Hydraulic module according to claim 2 of an oblique axis design in which connecting ducts are formed between the two drive units (2, 3) within the yoke (4).

9. Hydraulic module according to claim 2 of an oblique axis design in which the yoke (4) contains a feed valve (17, 8).

10. Hydraulic module according to claim 2 of an oblique axis design in which the yoke (4) has a scavenging valve (18, 9).

11. Hydraulic module according to claim 2 of an oblique axis design in which the yoke (4) is mounted with roller bearings in particular with tapered roller bearings on a fixed housing.

12. Hydraulic module according to claim 2 of an oblique axis design in which a pivoting connection, in particular a pivoting screwed connection, is provided between the yoke and the housing.

13. Hydraulic module according to claim 12 in which ports for feeding in and discharging scavenging oil are provided on the pivoting connection.

14. Hydrostatic mechanical power branching transmission having at least one hydraulic module (1) according to claim 1.
